(19) United States
(12) Patent Application Publication
(10) Pub. No.: US 2017/0353711 A1
(43) Pub. Date: Dec. 7, 2017

(54) SYSTEM FOR CAPTURING A TEXTURED 3D SCAN OF A HUMAN BODY

(71) Applicant: Shape Labs Inc., San Mateo, CA (US)

(72) Inventor: Alexandre Charles M. Wayenberg, San Mateo, CA (US)

(21) Appl. No.: 15/612,013

(22) Filed: Jun. 2, 2017

Related U.S. Application Data
(60) Provisional application No. 62/345,787, filed on Jun. 4, 2016.

(51) Int. Cl. H04N 13/02; H04N 5/445; G01G 19/50

(52) U.S. Cl. CPC H04N 13/0221; H04N 13/0253; H04N 13/0257; G01G 19/50; H04N 5/44504; H04N 2213/001

(57) ABSTRACT

One variation of a system for capturing a textured 3D scan of an human body includes: a base configured to support a user; a sensor assembly configured to record optical scans; a robotic arm coupled to the base and configured to move the sensor assembly along a helical path extending upwardly from and around the base during a scanning routine; and a controller configured to stitch optical scans recorded by the sensor assembly during the scanning routine into the 3D scan of the human body of the user.

### CROSS-REFERENCE TO RELATED APPLICATIONS

This Application claims the benefit of U.S. Provisional Application No. 62/345,787, filed on Jun. 4, 2016, which is incorporated in its entirety by this reference.

### TECHNICAL FIELD

This invention relates generally to the field of personal weight scales and more specifically to a new and useful system for capturing a textured 3D scan of a human body in the field of personal weight scales.

### BRIEF DESCRIPTION OF THE FIGURES

FIG. 1 is a flowchart representation of a system;

FIGS. 2A and 2B are schematic representations of one variation of the system;

FIG. 3 is a schematic representation of one variation of the system;

FIGS. 4A and 4B are schematic representations of one variation of the system;

FIG. 5 is a flowchart representation of one variation of the system;

FIG. 6 is a schematic representation of one variation of the system;

FIG. 7 is a flowchart representation of one variation of the system;

FIG. 8 is a flowchart representation of one variation of the system;

FIG. 9 is a schematic representation of one variation of the system;

FIG. 10 is a flowchart representation of one variation of the system;

FIG. 11 is a graphical representation of one variation of the system;

FIG. 12 is a graphical representation of one variation of the system;

FIG. 13 is a flowchart representation of one variation of the system;

FIG. 14 is a graphical representation of one variation of the system;

FIG. 15 is a flowchart representation of one variation of the system;

FIG. 16 is a graphical representation of one variation of the system;

FIG. 17 is a graphical representation of one variation of the system;

FIG. 18 is a graphical representation of one variation of the system; and

FIG. 19 is a graphical representation of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

The invention described here relates to the field of bathroom scales and fitness evaluation instruments and how people can use this invention to improve their health, fitness and appearance. A system 100 is described herein as an innovative apparatus that can capture a textured or non textured partial or full 3D scan of a human body. This new system may also be used to capture 3D scans of static or dynamic objects or environment.

In order to make a full or partial 3D scan of a human body, a sensor may rotate around the person or one or multiple sensor may be positioned around the person or the person may be rotated while one or several sensors are capturing.

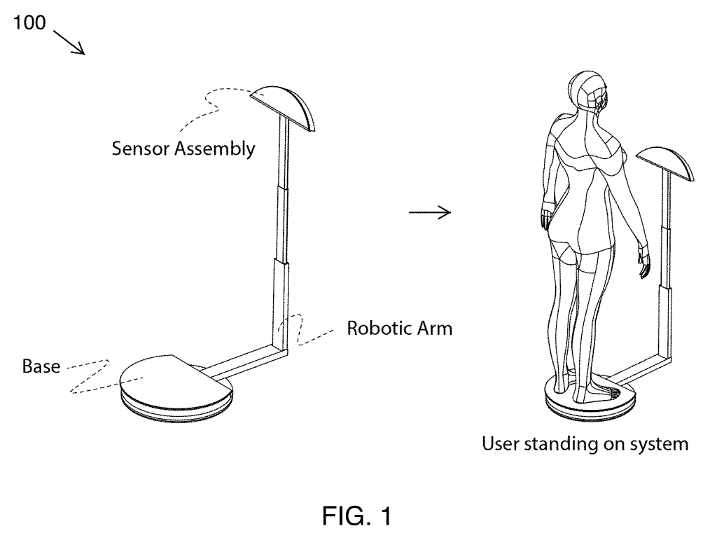

The innovative system is an apparatus that may capture a textured or non textured partial or full 3D scan of a human body. It consists of a base and one or several robotic arms attached to the base that move one or multiple sensor assemblies to capture a partial or full 3D scan. The person or object usually stand on the base but there are some scanning modes where the person or object may not stand on the base. FIG. 1 depicts one implementation of the system/device.

One variation of the system 100 for capturing a textured 3D scan of a human body includes: a base configured to support a user; a sensor assembly configured to record optical scans; a robotic arm coupled to the base and configured to move the sensor assembly along a helical path extending upwardly from and around the base during a scanning routine; and a controller configured to stitch optical scans recorded by the sensor assembly during the scanning routine into the 3D scan of the human body of the user.

### 2. Terms

A 3D scan may be a parametric or nonparametric representation of the object or person in a 3 dimensional space. It may be non-textured or textured using photorealistic color capture.

A computing device may be one of the following: a terminal, a desktop computer, laptop computer, a tablet, a smartphone, a wearable watch or any wearable computer including Augmented Reality and Virtual Reality device.

### 3. Base

The base may contain the required mechanism and motor to rotate or move the arm around the person or object. The base may contain sensors like weight sensors using load cells or any other method, bioimpedance sensor using 2 or more electrodes, heart rate sensor.

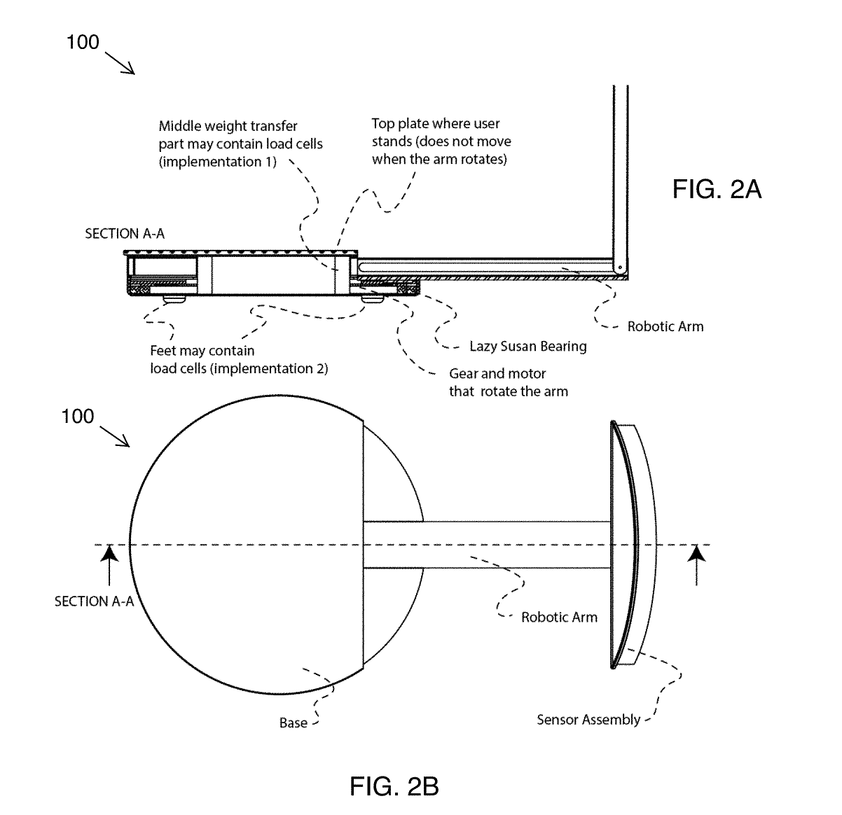

In one implementation, one or several load cells are used to measure the weight and may be placed inside the feet of the scale or inside the weight transfer plate. In another, the load cells are placed in the middle weight transfer part. Two implementations are shown in FIGS. 2A and 2B.

### 4. Computing Unit

The computing unit may be situated in the base, the robotic arm or one or several sensor assemblies. The processing unit can include: an embedded computer that store the data and then transfer it to a remote device or server; and/or an embedded computer that has processing capabilities through a GPU, MCU, CPU or FPGA or any other form of processing unit. It can then fully or partially process the data before to forward them to a database or another computing device. The computing unit also may contain a battery and a power management system used to recharge the battery. The computing unit may also contain one or several wired or wireless communication systems.

### 5. Robotic Arm

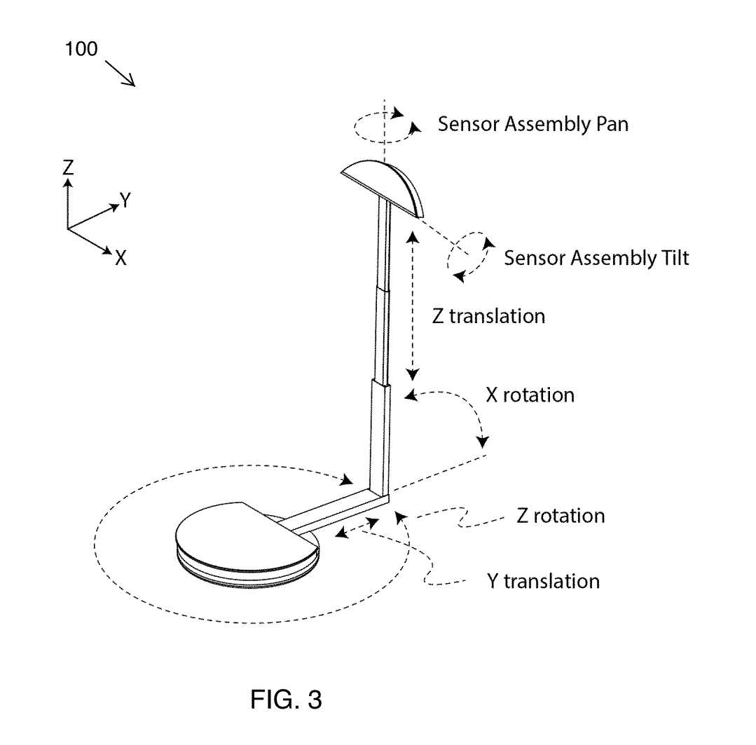

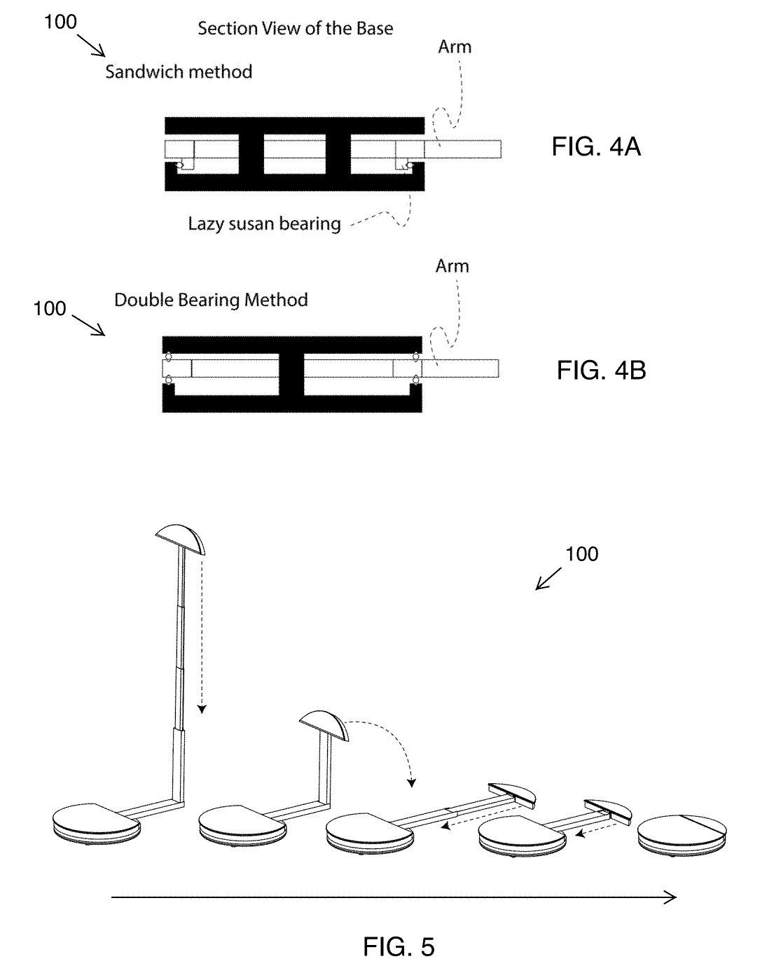

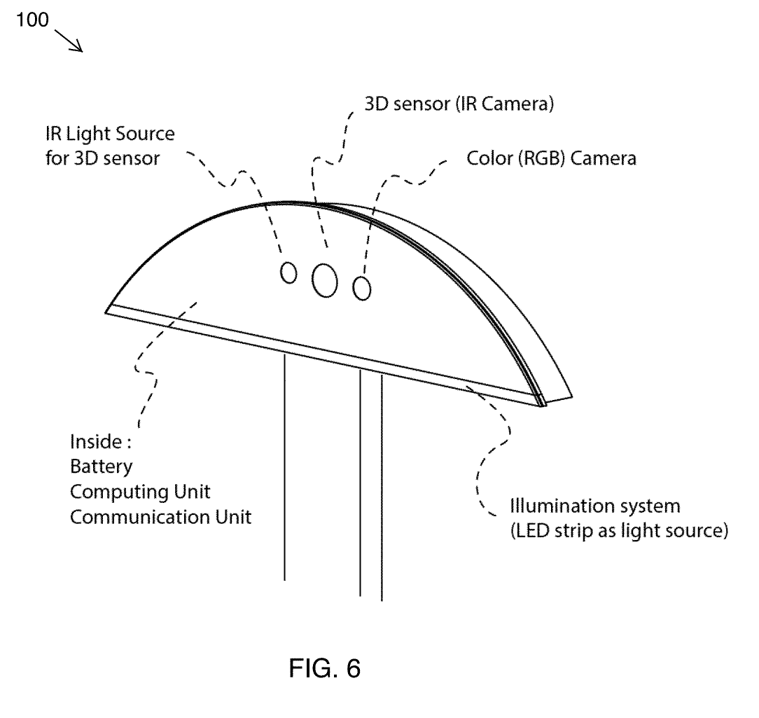

The robotic arm includes a section that extends from the base and manipulates one or multiple sensors around a user. The robotic arm may move and reposition one or multiple sensors around the object while the user or object may be on the base. The robotic arm may have the following degrees of freedom: rotation around the person or object standing on the platform along the z axis; movement along the y axis to adjust the distance of the sensor relative to the subject, this method can be used to increase the accuracy and precision of the 3D scan as the accuracy and precision of 3D scanning techniques depends of the distance of the sensor relative to the scanned object; rotation around the X axis; and/or movement up and down or translate along the Z axis. The sensor assembly can also pan and/or tilt. This is not an exhaustive list and the robotic arm may have several other degrees of freedom or may have less degrees of freedom. One implementation is depicted in FIG. 3.

One or several aforementioned degrees of freedom may be motorized and automated or may have to be manually adjusted by the user. In order to have the arm rotating around the person or object while the person or object stays immobile on the platform, the system may use one of the two following mechanical solutions.

The following methods may be used and are depicted in simplified view of Error! Reference source not found. In a sandwich based method, the arm is attached to a bearing the platform is lying on another static part that lie inside the bearing. The weight of the person is transferred through this central part weight transfer part. In a double-bearing method, the weight of the person or object is transferred through a double bearing that allows the top plate and bottom plate to remain static while the arm rotates around the platform may be held static using a center rod.

The system may use any other kind of bearing like ball, roller, sliding contact, etc. to achieve the result of moving the arm while the user can stay without moving on a platform. The robotic arm may be telescopic so it can extend and retract, it also may be foldable. In one implementation, the robotic arm may retract into the base. In case of the retractable version, the robotic arm may retract entirely inside the base. This may allow to completely hide the robotic arm from the user. One implementation is depicted in FIG. 5. Other implementation may be used to retract the robotic arm entirely into the base so it does not protrude from the base or fold on top of the base.

### 6. Sensor Assembly

The robotic arm and the base may contain one or multiple sensor assemblies. Each of this sensor assembly may contain the following: a 3D scanning sensor; a normal RGB camera; an illumination system; a computing/processing unit; a communication unit; and/or a battery. One Implementation of a sensor assembly is depicted in Error! Reference source not found. 6.

In one implementation of the product, one or several sensors in the sensor assembly or the whole sensor assembly may be replaced by a mobile computing device that has a camera which may possibly be the user's device. In this implementation, the mobile computing device may be held in place on the sensor assembly or robotic arm using a clamp. The software running on the mobile computing device may remotely control the movement of the robotic arm and retrieve data of the sensor included in the base or the sensor assembly using wired or wireless communication.

### 6.1 3D Scanning Sensor

The 3D scanning sensor allows the system to capture the 3 dimensional geometry and position of a person. This 3D scanning sensor may use any of the following technique or a combination of the following technique to capture the 3D position and geometric topology. These 3D scanning techniques may be but not limited to a time of flight camera, Visible and non-visible structured light, photogrammetry, laser dynamic range imager, light detection and ranging (Lidar), laser triangulation, stereoscopic and photometric data, polarization of light, or similar and may even make use of a combination of several of the above mentioned techniques to create a textured or non textured 3D scan. These 3D scanners may use visible light or invisible light (e.g. infrared) to illuminate and capture the object or person.

### 6.2 Normal RGB Camera

The robotic arm also may contain one or multiple regular RGB camera that capture color pictures of the subject. The standard camera is used to capture a colored texture of the object. It also may be used to generate 3D scans using photogrammetric methods.

### 6.3 UV Camera

The sensor assembly may use a camera and illumination system that emits and is sensible to a certain range of ultra violet rays. This may allow to capture and detect skin age spots.

### 6.4 Illumination System

The sensor assembly also may contain a light emitting device that allows to illuminate the person or object. This illumination system or additional similar or different illumination system may also be located the base, the robotic arm or even an external illumination system. The illumination system is important to create homogeneous illumination of the person or object in order to create a uniform color texture using RGB cameras.

In one implementation, one or multiple light emitting device is included in the sensor assembly. These light emitting devices may be LED capable of providing light at a fixed or variable spectrum (color).The device may also optimize the wavelength and intensity of light according to the external illumination in order to counterbalance or minimize the effect of environmental light condition and provide optimal illumination of the subject to capture. This illumination may be used to create varying contrast that allow to perform 3D reconstruction using photometric data.

### 6.5 Vibration and Motion Tracking

The sensor assembly or robotic arm may include motion, position, orientation or acceleration tracking of the sensor and/or the robotic arm in order to optimize the data captured and the reconstruction.

### 7. Communication Between the Base and the Sensor Assembly

In the particular implementation case of the processing unit being placed in the sensor assembly and other sensors like weight sensors and bio-impedance sensors being placed within the base of the device, the two units may need a way to communicate together in order to aggregate the data. This may be done through cables or using wireless communication.

When it is required, the device connect and relay the data through a wired or wireless connection to a remote server or to a user computing device. This is generally done but not limited to Wifi. In the case of the remote or cloud server, the information may be relayed through internet or any other computer network or even the user's computing device.

### 8. Sensor Calibration

The base or robotic arm may contain geometric and color markers that allow to automatically recalibrate one or multiple sensors. This may be used to align the output of the 3D scanning sensor and the camera (align picture with 3D scan).

### 9. Scanning Methods

The robotic arm may move one or multiple sensor relatively to the person or object to be scanned. Because of the that the device is able optimize the motion pattern required to 3D scan a person or object fully or partially according to the 3 dimensional geometric topology of the person or object. The precision and accuracy in most of 3D scanning methods is proportional to the distance of the person or object scanned. When the sensor is further from the person or object, it captures more data relative to the entire object or person but with less precision and accuracy. When the sensor is closer to the person or object, it will be able to capture data relative to the entire object or person but with more precision and accuracy. The innovative device allows to optimize for faster or more accurate and precise scanning.

The device may optimize the motion in order to: scan a full body or object; scan specific part of person or object, such as a face, arms, legs, feet, torso, belly or even any specific area that is susceptive to accumulate fat, show effect of aging or even specific muscles; perform a scan at a lower height and partially capture the body; scan a subset of a body, such as the face or head of a person.

### 9.1 Full Body Scan

The full body scan may be performed by the motion of the arm and the sensor around the person. The device optimizes the optimal motion of the different degrees of freedom according to the 3 dimensional geometric topology of the person. This motion optimization may take place in real time or not. Here is an example: the system may limit the height of the vertical translation (Z axis) of the sensor assembly and pan if the person scanned is less tall.

The scanning motion pattern necessary to perform a full body scan may combine one or several of the following motions: Z rotation, the robotic arm rotates the sensor around the person; Z translation, the sensor moves up and down in case there is one sensor, in case of several sensors the up and down motion may not be necessary; X rotation; and/or Y translation, the sensor moves back and forth adjusting the distance from the person. The sensor head can also tilt and/or pan.

Due to the size of the person, the top of the head may not always be captured, the top of the head and haircut may be reconstructed using several reconstruction techniques.

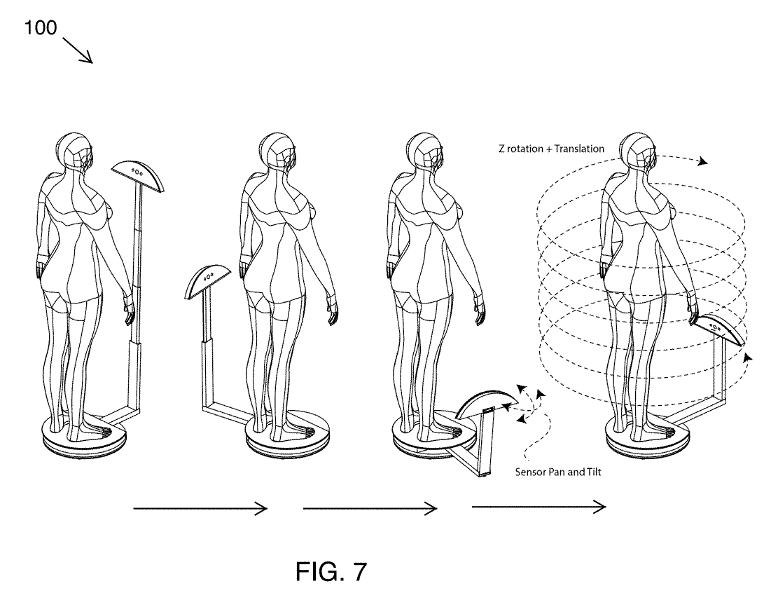

FIG. 7 depicts one implementation of the motion used to perform a full body scan: The sensor may translate up and down while rotating around the person. The sensor accomplishes one or several rotations. Pan and tilt movement may be used as well to capture the entire body faster.

### 9.2 Specific Part Scan

The different motions and degrees of freedom used in the full body may be combined to scan specific area, body part or even muscle. This may be done to capture the scan faster because the user is interested in that area or to capture more precise and accurate data.

9.2.1 Partial Body Scan from the Bottom

Because of the flexibility of the motion offered by the robotic arm, the sensor might perform a partial body scan by rotating around the person without translating up and down along the Z axis. This method allows to perform a faster scan but is limited as it won't be able to capture the whole body. This missing body part can after be reconstructed using previous scan data or using a database of body models.

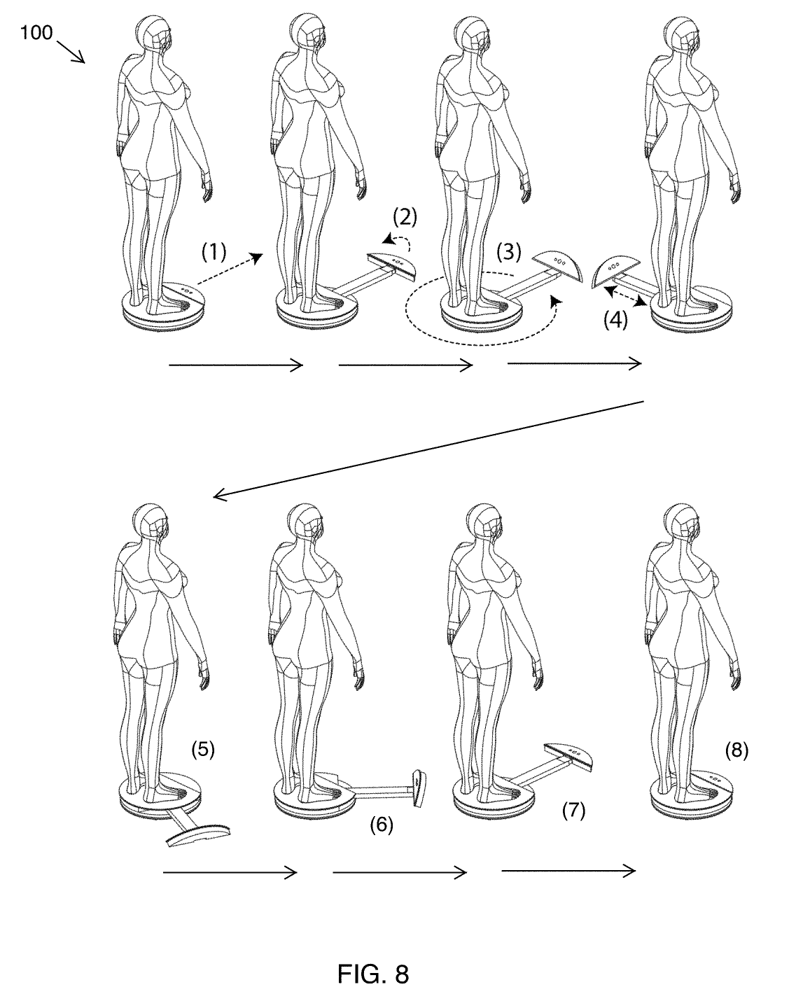

One implementation of the bottom scanning motion is depicted in FIG. 8. It may include an extension movement from the base depending on whether the robotic arm is retractable or not. This bottom scanning motion pattern may combine one or several of the following motions: tilting the sensor head, which allows to sweep across the body, rotating the sensor around the person, adjusting the distance of the sensor to the base.

### 9.2.2 Face or Head Scan

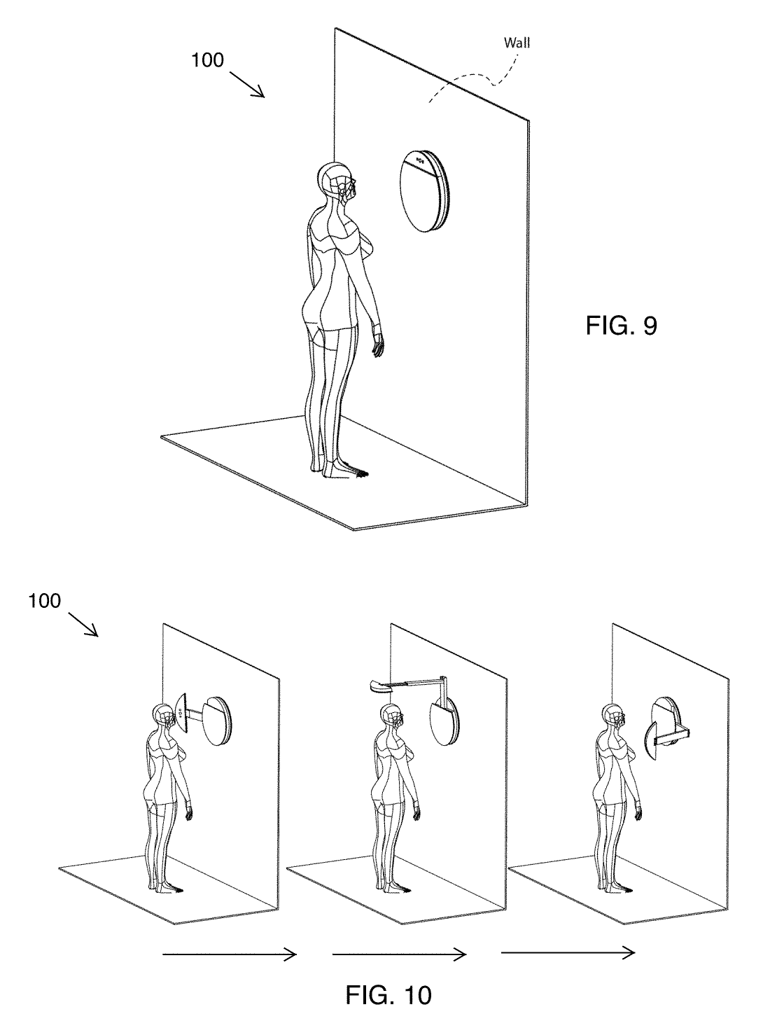

Other methods can be used to scan the face or head but the system describes here a specific case that would allow to scan the face with greater convenience and accuracy. In this particular case, the base of the device may be attached to a wall or a vertical surface. One possible way to attach the system on the wall is depicted in FIG. 9.

The same motion explained in the full body scan may be utilized in order to scan the face or head of a person with higher precision as is depicted in FIG. 10.

9.3 Scan from Ceiling

The base may be mounted upside down on a ceiling (feet against the ceiling surface) and perform any of the type aforementioned scan form the ceiling.

### 10. Processing Captured Data

The data that is captured by the system may be partially or completely processed in the following ways: processed directly by the system; processed on a mobile or non-mobile computing device: smartphone, tablet or wearable computer, laptop or desktop computer of the user; processed on a remote or cloud server. The processing may also be spread across these 3 different ways.

Processing may be performed according to the following steps, additional intermediate steps may be required like for example sampling and filtering might also be required or introduced in between these steps. Some steps may be also removed without affecting the validity of the other ones: The sensor or multiple 3D sensors generally relay the 3D information in form of image frames where the depth information is encoded as gray scale images. The distance to a certain point of an object is represented by a pixel where the grayscale represents the magnitude of the distance. Remark: this is not the case for some technique like for example photogrammetry. In another implementation, each pixel in the frame is converted to a 3d point that is relative to the position and orientation of the sensor. After the image is processed, the system effectively has a point cloud. This point cloud represents part of the model in three dimensional coordinates. Additionally or alternatively, using information from motion sensing (gyroscope, positioning sensors and accelerometer) the algorithm evaluate most probable position and orientation of the sensor in the next frame. After evaluating the position of the sensor, an Iterative Closest Point algorithm is employed to minimize the difference between two points clouds and refine the position of the sensor.

3D scanning systems may lose tracking because the sensor moves too fast and there are not enough point that can be correlated to find the new position and orientation of the sensor. Because The system is controlling the movement of the sensor, the system can optimize the speed of the movement and orientation according to the 3D geometric topology in order to avoid losing tracking. If the tracking of the position and orientation of the sensor is still lost the system may also bring back the sensor to a previous position or restart. This method may also be used to detect if the person or object is moving.

If colored photos are captured, the 3D information of the person may be used to filter unnecessary information from the image that are part of the background. This reduce the size of the information that may be needed to transfer for post processing. This is easier to do on the system since the system can ignore information that is not inside the radius of the rotating arm. If multiple sensors are used, the overlapping information may be used to fuse the different dataset together using an Iterative closest point algorithm or another method.

### 10.1 Specific Area Improvement

In some case the RGB data from captured images may be used to augment the data coming from the 3D sensor using photogrammetry. Photogrammetry is using the combination of several images with different perspective of the same part in order to create a textured 3D model of the part. The system may combine the preexisting information of the 3D scan with the photogrammetric reconstruction method in order speed it up and make it more accurate. This can be particularly useful to obtain greater data for certain area that may include but are not limited to: the face, hairs, genital parts, legs.

This method can be used to refine an area with wrinkles or ripples, like face wrinkles or cellulite on legs. The model generated using photogrammetry is then fused to the 3D model created with the 3D scanning sensor.

### 10.2 Reconstruction of Missing Parts

In case the data from the sensor are not overlapping or some data are missing from the 3D scan, parametric body models or data from previous scans may be used to fuse the data together or reconstruct missing part of a 3D scan. A similar method may be used to reconstruct the missing part of a texture.

### 10.3 Realignment of Different Postures

When a user is scanned several times, the body posture will vary across several scans. Because of this the system may realign 3D scans taken at different times. To do this, the system implements a database of morphable human models. They are morphable in the sense that the different joints and articulation can be reoriented to match the body shape and orientation of the body model. Once matched position and orientation of the different joint may be transferred to the 3D scan of which to prompt the user to adjust her posture. The system may use a complex model of the body that take in account the skin, muscle, fat tissue, bones, etc. to calculate the deformation of the 3D scans according to this new posture.

### 11. Applications and User Interfaces

The following applications may rely on information captured by the aforementioned system. The data might be captured by a different system or method that would capture a non textured or textured 3D scan. The software may display all of the following applications on a computing device. When the data displayed are 3 dimensional, the user may zoom rotate or translate the view in 2 or 3 dimensions in order to obtain more details or change the part is he is viewing. The user may interact with the different representation and interface according to the different controls available on the computing device, this may include mouse, keyboard, touch, pencil, hand or head gestures, etc.

### 11.1 Instant Evaluation

By instant evaluation the system may extract data from a single scan and directly display these data to the user.

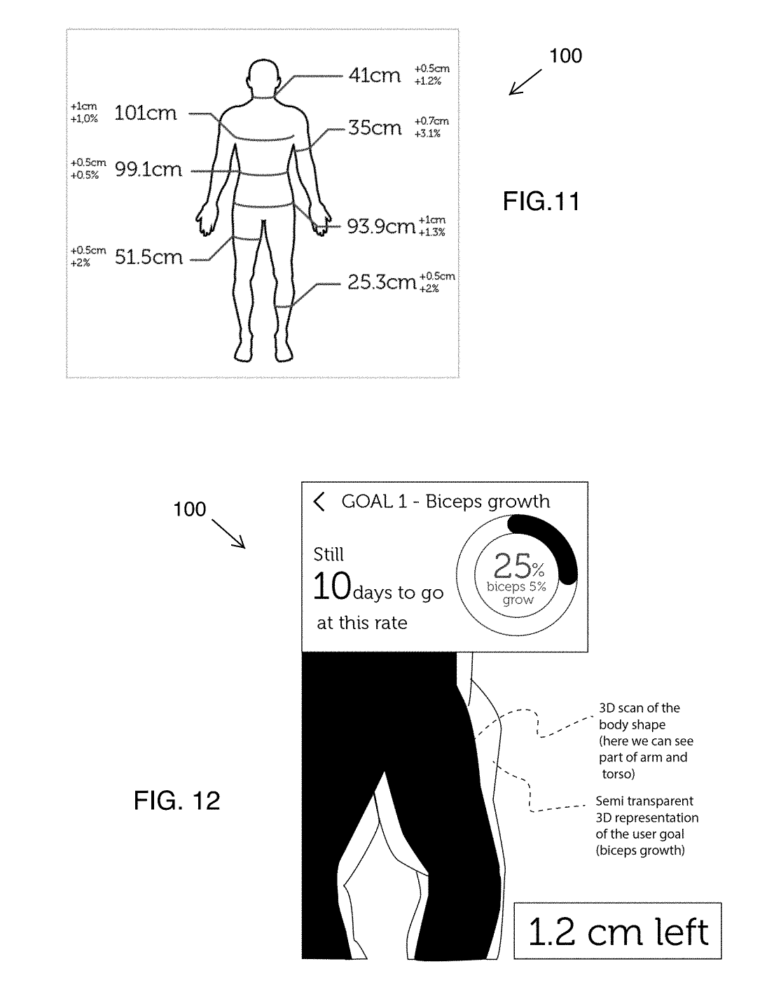

From the 3D model, the system can extract length measurements information, these measurements may be perimeters, circumferences, inseam, linear length (thickness, width, height) or even ratio between measurement (e.g. waist to hip ratio). Additional measurement used for clothing design might also be extracted from the 3D model. The user interface may display the information may be one of the following: having all the measurement displayed in one screen like in the FIG. 11; having the 3D scan displayed and being able to tap on a part of the body to display the corresponding measurement of a predefined area or a specific one.

### 11.2 Weight Measurement

If the implementation includes weight measurement, the system may display weight and the evolution of the weight.

The system may use the different measurement of volume, length and fat in order to calculate and display indexes like the Body Mass Index, the Body Volume Index, Sagittal abdominal diameter. The 3D scan and data collected from the sensors might be used to compute a proprietary index that indicates to the user that his body shape is improving according or not to his selected goal.

The 3D scan may be used to identify and display the body type of the user to the user. The system may use the classic body type classification (the endomorph, characterized by a preponderance of body fat; the mesomorph, marked by a well-developed musculature; and the ectomorph, distinguished by a lack of much fat or muscle tissue.) or another classification.

### 11.3 Volume and Fat Percentage

From the 3D model, the system can extract the volume using different possible methods. This may allow to evaluate the volume of the whole body or the volume of specific parts like for example but not limited to arms, legs, torso, belly, butt, etc. Combined with the information of the weight, this allows to calculate the mass per unit of volume or the density of a person's body.

Using body models and prior data, the system may also evaluate the density, 3D position and geometric topology of the different part that makes a body: bones, organs, fat tissue, muscles, etc. Data captured from CT scans, Dexa scans or MRI scans might be used to create a better model. Several methods and algorithms allow to correlate the density with fat percentage and weight of fat. Depending on the implementation, the system may use this method in combination with other methods like bioimpedance measurement in order to obtain more accurate data.

### 11.4 Muscle and Muscle Tone

Based on the 3D scan, the system may calculate a parametric or nonparametric 3D representation of the different muscles. This may be done for all the muscles or part of the muscles. This may allow us to calculate length, circumference, weight or volume or toning level of one or several muscles and display these parameters to the user.

Using several 3D scans, the system may display one or several muscles to the user and show how the muscles have been changing over time in terms of length, circumference, weight or volume or toning level. The toning level or state of tension that is maintained continuously and even when relaxed. The toning is visible because it changes the 3D repartition and topology or 3D shape of the muscle. The system may use a mathematical model to evaluate and quantify the residual tension in the muscle when it is relaxed. The muscle model may be used to evaluate the movement of the muscle when the person is flexing muscles muscles or bending different articulation of the body.

The system may ask to the user to take several scans with different poses or several poses during one scan in order to create the muscle and muscle toning model. The system may possibly take a scan of a person flexing and not flexing their muscles so the system can create a more accurate parametric or nonparametric model of the different muscles. This may be done for the whole body or for specific muscles.

The following extracted information may be displayed to the user: absolute value is displayed for the muscle length, circumference, weight or volume; relative muscle variation of these values between two 3D scans; absolute value is displayed for the muscle toning; and/or relative variation toning between two 3D scans. Graphs displaying variation over time of the muscle toning and muscle volume.

The system may use a similar model to the toning model to evaluate and display toning information for a flexed muscle. Timelapse video animation or series of images may also be generated and used to display the evolution over time of a specific muscle or group of muscles.

### 11.5 Hydration Level

Using RGB images and 3D scanning, the system may evaluate the skin and body hydration level. This may be displayed on an absolute or relative scale.

### 11.6 Wrinkles

The 3D scan and possibly the refined version that use photogrammetry may be used extract and display the following data about wrinkles: amount of wrinkles; depth of wrinkles; and/or length of wrinkles.

### 11.7 Cellulite and Stretch Marks

The 3D model combined or not with a color texture may be used to measure the surface of the skin covered by cellulite and stretch marks. The data may be measured by using any method that can evaluate the smoothness of a 3D mesh and may as well use the distribution of color in the texture. Based on this information, the system may give the amount of surface of the skin covered by the cellulite and the severity of the cellulite.

### 11.8 Skin

The 3D model and textured model may be used to evaluate the following parameter about the skin: skin type, such as including, normal, dry and oily; skin color (e.g., skin tone); skin conditions; and/or skin quality (e.g., in terms of the homogeneity of the skin color and roughness across a defined skin surface).

The system may implement similar or adapted parameters from ISO 25178: Geometric Product Specifications (GPS)—Surface texture and combine them in order to provide skin quality measurement value.

### 11.9 Comparison to Statistics

The system may display to the user how these different parameters are compared in comparison to the population and statistics about parameter over a sample of a geographic location. For example, the system may display to the user that he is heavier than 70% of the population in the USA or simply that his body shape is in the top 3 percentile.

### 12. Goal Settings and Visualization

The system allow the user to setup fitness and appearance goals and directly visualize them on his 3D scans.

### 12.1 Goal Settings

Goal settings may be setup using the following ways: 1) Using simple sliders, the user interface may be the following: As selection slider may represent the level of effort for the exercising and the dieting. 2) The user may also select from different simplified goals like “gaining muscle”, “lose fat”, “tone”, “maintain”, “perform better”, “rejuvenate”. 3) The user may be proposed different 2D or 3D body shape from which he can select in order to indicate that he aspire to them. 4) Using a more advanced mode where the user may directly act on body parts. He may decide to grow or reduce muscle, fat or tone certain body parts. Body parts may be more general like for example the waistline or belly or more specific like specific muscles. The interface may give a direct feedback by showing the modified 3D scan to the user so the user can visualize how he would look like in the future.

### 12.2 Goal Visualization and Shape Evolution Prediction

After setting goals, users may have the ability to visualize their progress towards the goals that they have set up. to the following. One implementation is shown in FIG. 12Error! Reference source not found.

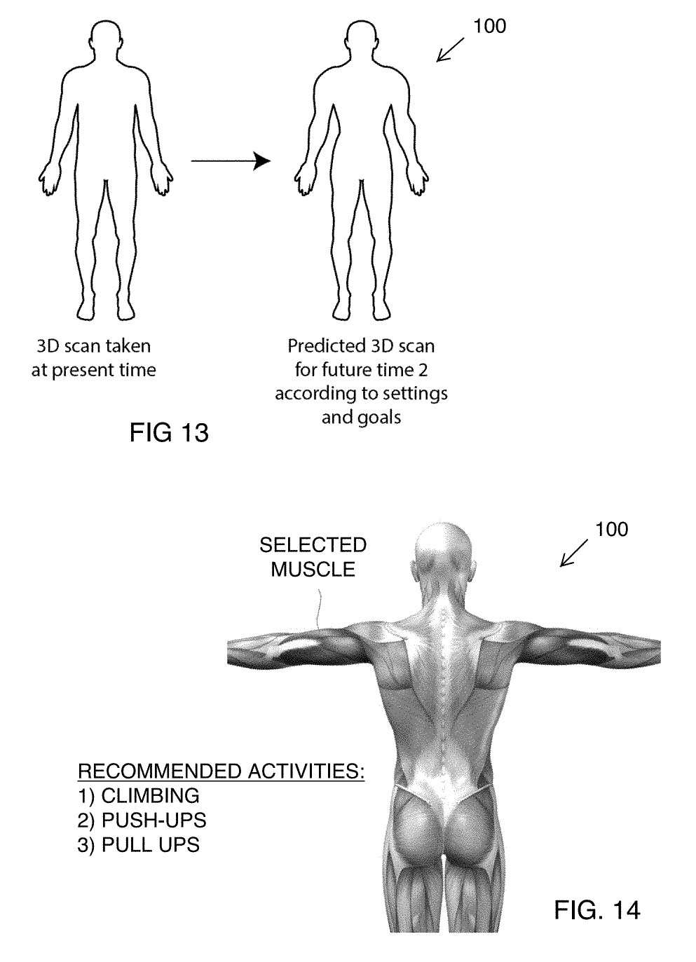

The data that the system collected from previous users may be used to predict how the same or other user's 3D body shape will evolve over time according to a certain level of exercise and effort or even according to a specific exercise and dieting plan. The system may predict and display to the user the future evolution of his 3D body shape like explained in FIG. 13.

### 13. Coaching

The software may evaluate what immediate improvement that can be taken in order to improve the appearance, fitness or health of the user. The user interface may highlight body zones that are recommended to improve and propose a matching diet and exercise plan that will lead to improvements.

### 13.1 Diet Plan

After the user set up his goal, the system may provide him dietary recommendation or even a full meal plan in order to reach the specific goal that he has set. Since the system may measure the progress of the user, the system may adjust the plan according to the user's progress.

### 13.2 Exercise and Activity List

After the user entered his goals, the system may propose the user to choose to perform one or several exercises or activities over a certain period of time. The user may also select an area or a muscle like in FIG. 14. The software may propose a list of activity or classes that can help the user to reach their goal(s).

### 13.3 Visualize Activity and Activity Effects

The user may be able to visualize the effects of certain sportive or dietary choice on his body shape. Like for example show the user how he would look like in 6 months if he chose to continue to follow a certain diet or follow an exercise plan. The system may highlight the different part affected by an exercise or diet directly on the 3D scan of the person. Example, the system may highlight on directly on the 3D scan which muscles and muscle group are activated by a push-up exercise.

Since the system may use a posture readjustment method that morph the 3D scan to readjust the posture, the system may use a similar method to show an animation of 3D scan of the user performing exercises. The user could then for example visualize his 3D scan performing a series of push-ups. Recommendations may be given on how to perform the exercise properly.

### 14. Cosmetic & Aesthetic Treatment Recommendations

The system may offer to the user recommendations on which cosmetic to use according to the type of skin, quality of skin and also potential skin conditions.

In a similar manner, the system may offer recommendations on any form of aesthetic treatment corresponding to the goal the user. The system may also show to the user the effect of some aesthetic procedure including but not limited to invasive and non invasive plastic surgery directly on his 3D scan. For example, the system may display to a female user a choice of new size of breast that she could directly visualize on her own body using the 3D scan.

15. Progress and change visualization

The software may offer to the user the possibility to visualize the variation over time of the different instant measurements made in the Instant Evaluation Section. These may be under the form of 2 dimensional or 3 dimensional graphs.

### 15.1 Difference View

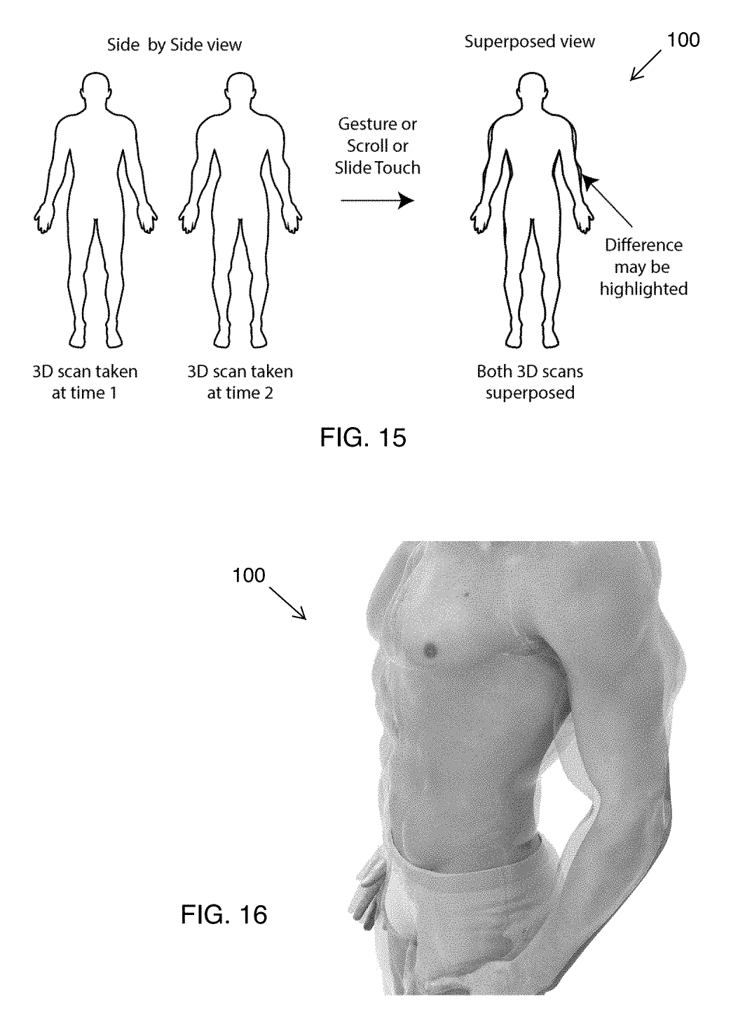

The system may display the differences between two 3D scans of the same users at two different times. In one implementation like shown in FIG. 15, the user can visualize the 3D scans side by side and with a simple gesture, touch or scroll superpose the two scans, one scan may be selected to be semi transparent in order to be able to visualize the difference between both 3D geometries like in FIG. 16.

### 15.2 Heatmaps

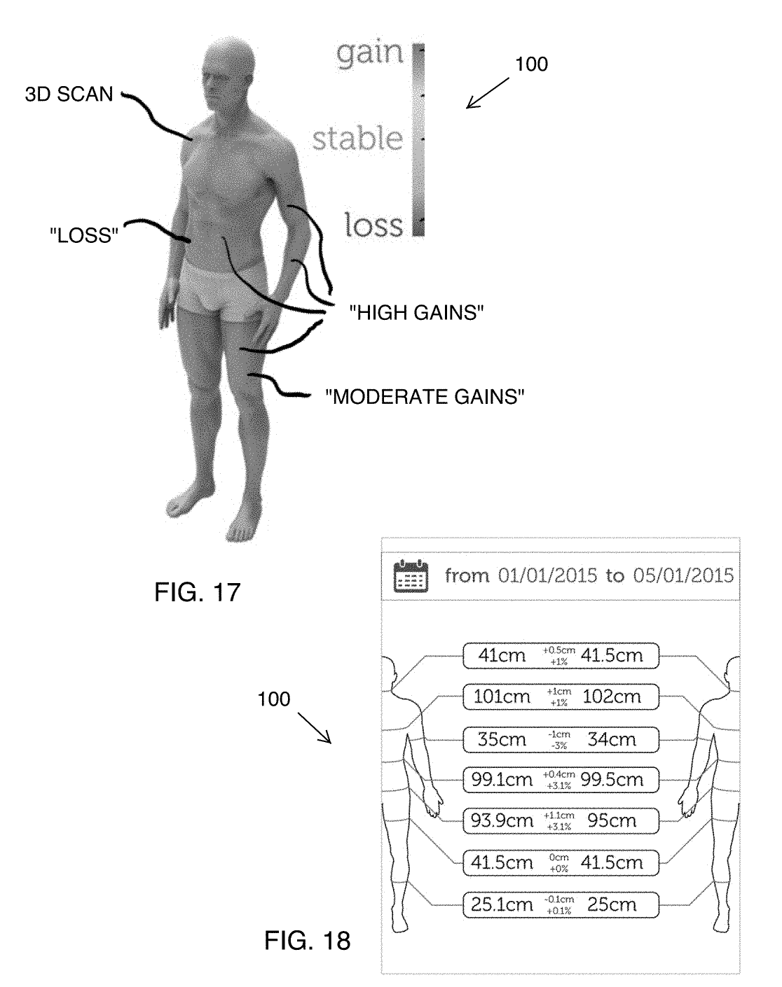

The system may display the differences between two 3D scans using colors and color gradients that represent the amplitude and the sign of the volume variation between the two scans. This is depicted in FIG. 17. This amplitude of the variation may be a colored representation of the mathematical gradient. An example would be a representation where the blue color is representing a higher loss of volume, a clearer blue color a less high loss of volume, the yellow color would represent a small gain of volume, the orange color a medium gain of volume and the red color a large gain or volume.

### 15.3 Timelapse

The system may display the progress of the 3D body shape of the user over time in the form of an animation that use the different 3D scan collected at different time and interpolate the different scan using 3D morphing technique. The result may be an animated 3D video of the changing body shape. This video may be interactive and the user could zoom in and translate to focus on any part he is interested in.

In the same way, the user may browse quickly a collection of 3D scans over a large period of time and they would be morphed in such a timelapse animation. The faster the user scroll using gesture, touch or mouse, the faster the body would change. In one implementation, the data and interface may display the time and/or date under the scan the user would then scroll left or right. One scrolling direction may represent browsing in the future where the shape evolution prediction model may be used to display to the user how he may look in the future. The other scrolling direction may represent the past and display the collected data at the selected time/date and morph them progressively as the user scroll back to the past. The user then may scroll back and forth and visualize the change.

The timelapse may be combined with heatmaps in order to highlight the changing zone in the 3D body shape with one or several colors or color gradients.

### 16. Measurements

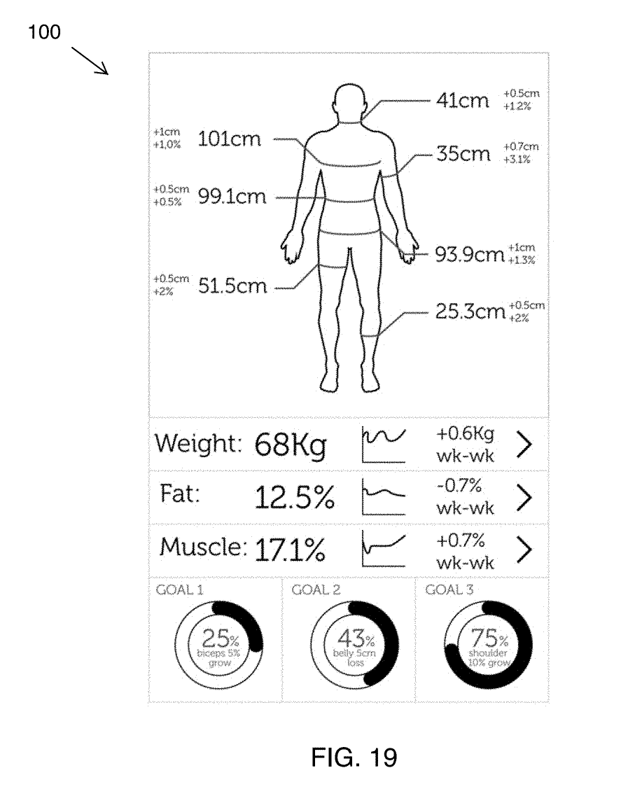

The system may display comparison between body measurements taken on 3D scans at two different points of time like shown in FIG. 18. The system may regroup different information in a dashboard. In one implementation the dashboard may be arranged like in FIG. 19.

### 17. Social Applications

The different parameters captured and method described may be used in a social competitive context where two or more users may compete on several of the parameters measured by the system. Any of the aforementioned method may be used to compared the body of two or more different persons.

The system may allow to share 3D scan or data captured with the system in order to request the feedback of one or several other persons. The system may allow to restrict the access to specific persons or to share it publicly.

The different parameters captured and method described may used to compare the body of a person to different beauty standards.

### 18. Other Applications

In case of several users using one system. The system may use the different data measured and different method to detect which user has been using the system.

The system, device and captured data may be used in additional application like visualize how one's kids are growing and their body shape is changing, visualize how the body shape is evolving during a pregnancy, evaluate the body age, visualize the progression of wrinkles, visualize the effect of aging or stress, visualize how the children of two persons would look like (The system may combine the 3D scan of two different users, male with female or even male with male and female with female in order to predict how their children would look like), assess and visualize the effect of cosmetics and cosmetic creams on skin, create gaming or virtual reality avatar, detect eating disorder like anorexia, detect other health conditions, visualize yourself dancing, visualize yourself wearing clothes or accessories, visualize yourself with a different haircut, capture objects and evaluate their density, capture food in order to evaluate the volume and calorific content.

### 19. Privacy Setting & Data Anonymization

The system may allow the user to select a data privacy setting. He may decide if and how the information of his 3D scan is anonymized and whether or not the data is forwarded or not to remote servers. Different levels of data anonymization are possible and can possibly be combined. In one example, all information is send to remote server. In another example, partial information is sent to remote, such as: remove information about head and or face 3D geometry; remove information about genital parts 3D geometry; remove texture information for the whole body; remove texture information for part of the body; and/or remove the link between information and his name or user name. In another example, the system decides that no information is sent to remote servers and that full or partial information are stored on local device of the user.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system for capturing a textured 3D scan of a human body, comprising:
a base configured to support a user;
a sensor assembly configured to record optical scans;
a robotic arm coupled to the base and configured to move the sensor assembly along a helical path extending upwardly from and around the base during a scanning routine; and
a controller configured to stitch optical scans recorded by the sensor assembly during the scanning routine into the 3D scan of the human body of the user.
